(19) United States
(12) Patent Application Publication
(10) Pub. No.: US 2025/0384505 A1
(43) Pub. Date: Dec. 18, 2025

(54) HOLISTIC EARLY LEARNER ASSESSMENT SYSTEM AND METHOD

(71) Applicant: Sprig Learning Inc., Ottawa (CA)

(72) Inventors: Faud Ahmad Khan, Ottawa (CA); Jarrett William Laughlin, Ottawa (CA); Jared Broughton, Ottawa (CA)

(21) Appl. No.: 19/235,702

(22) Filed: Jun. 12, 2025

Related U.S. Application Data
(60) Provisional application No. 63/658,930, filed on Jun. 12, 2024.

(51) Int. Cl. G06Q 50/20; G09B 5/06

(52) U.S. Cl. CPC G06Q 50/205; G09B 5/065

(57) ABSTRACT

An early learning assessment system and method using an interactive assessment device in a culturally sensitive and holistic manner. Each learner has a learner profile with learning assessment data and learner activity data. Learning assessment is done across various learning domains and analyzed in a prescriptive learning engine to assess learning in young learners across a plurality of research-identified core learning skills and provides an indication of skill mastery for particular learners across the core learning skills as well as a learning path with activities for learning appropriate to the learner's skill.

### CROSS-REFERENCE TO RELATED APPLICATIONS

This application claims priority to United States provisional patent application U.S. 63/658,930 filed 12 Jun. 2024, which is hereby incorporated by reference herein in its entirety.

### FIELD OF THE INVENTION

The present invention pertains to a system and method for the assessment of early learning using an interactive assessment device. The present invention also pertains to the assessment of learning and identification of specific learning gaps in a culturally sensitive manner through the use of equity-designed, culturally appropriate assessment tools.

### BACKGROUND

Development of math and reading skills by the end of grade three is the basis for lifelong learning. Children learn on a continuum such that each skill that they pick up and improve at opens up new opportunities to learn and master new skills. Current systems of assessment are often based on the core learning domains of reading and math, however intellectual development in children involves many other different learning domains, and assessment across these other learning domains can be beneficial in understanding how children are learning and progressing. Early identification of gaps or challenges in learning can also assist educators to provide specific instruction in targeted areas. Furthermore, young children around the world are growing up in culturally diverse ways, and learning in any domain, whether in reading or math or in other more culturally relevant areas, can both contribute to learning improvement in all learning domains. Providing culturally sensitive educational curricula that incorporates culturally relevant learning domains, as well as game-based assessment approaches within these learning domains in a culturally accessible way, enables young children to learn more effectively and efficiently as well as have their skill mastery be more accurately and regularly assessed across all learning domains.

Electronic learning systems (ELM) and learning management systems (LMS) are software applications used for the administration, documentation, tracking, reporting, automation, and delivery of educational courses, training programs, materials, or learning and development programs. In one example of an electronic learning system, United States patent U.S. Pat. No. 11,676,504B1 to Holt et al. describes a learning method and system which grants user access to an appropriate activity module, determines the skill level of the user, and prevents access of the user to certain activity modules while granting user access to other activity modules. In another example of an electronic learning system, U.S. Pat. No. 10,720,072B2 to Loh et al. is directed to an interactive learning platform with a database of problems, database of pupils, including student and problem ratings, with each problem tagged for related concepts. A corresponding user specific comprehension rating for at least one subject area and the problem difficulty rating of the practice problem is generated based on whether the answer includes a correct or incorrect response.

Many educational learning systems are directed toward evaluation of a single student or learner, however most students around the world still learn in groups or classes with a teacher delivering educational material and guiding their education. Students in these classes are often at a broad range of levels across various learning domains, and traditionally teachers use the “spray and pray” approach, or delivery of what they believe is appropriate subject matter in hopes that the subject matter is received and understood by some or most of the students. Further, the assessment of young children in the earlier grades (i.e. up to grade 3) can be very challenging, as tests and assessments add layers of anxiety for children, often influencing their ability to express themselves and demonstrate their knowledge at this discreet moments of assessment. Added to this that when we look to assess literacy and numeracy at younger ages, many children are unable to read and we rely on observational and oral language assessments to determine skill mastery. Further, with marginalized students there are layers of assessment bias when the cultural and linguistic background of the teacher is different then that of their students. There remains a need for a more holistic and methodical way for teaching and learning assessment of individual students and groups in a way that is sensitive to the needs, stage, and cultural and linguistic backgrounds of every learner.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for assessment of early learning using engaging and game-based assessment using interactive devices to assess early learning across a plurality of learning domains and identify specific skill gaps. Another object of the present invention is to provide a system and method for assessment of learning in a culturally sensitive manner through the use of culturally appropriate assessment tools. Another object of the present invention is to provide a system and method for assessment of early learning and assisting teachers with educational practices to address the educational needs and learning progress of all students across a plurality of learning domains.

In an aspect there is provided a system for learning assessment comprising: a learning assessment database comprising a plurality of learning assessment modules and a plurality of core learning skills, each learning assessment module associated with and for assessing one or more core learning skills; an interactive assessment device comprising a display screen and an assessment application displayed on the display screen to receive learner assessment data for the one or more core learning skills being assessed, and a processor for receiving the learner assessment data relevant to the learning assessment module; a learner profile database comprising a plurality of learner profiles for a plurality of learners, each learner profile comprising a learner identification, the learner assessment data from each learning assessment module attempted by the learner, and an identification of skill mastery of the learner in the plurality of core learning skills in the learning assessment database; a learning activities database comprising a plurality of learning activities, each learning activity associated with the one or more core learning skills; and a prescriptive learning engine for receiving the identification of skill mastery of the learner in the plurality of core learning skills for at least one learner and prescribing at least one learning activity from the learning activities database based on the skill mastery of the at least one learner in the one or more core learning skills.

In another aspect there is provided a method for assessing an early learner comprising: providing a learner with a learning assessment module, the learning assessment module associated with a plurality of core learning skills; assessing the learner on the plurality of core learning skills; for the learner, assigning a skill mastery status for each of the plurality of core learning skills being assessed by the learning assessment module; storing the skill mastery status for each of the plurality of core learning skills in a learner profile for the learner; and selecting at least one learning activity from a learning activities database, the at least one learning activity associated with at least one core learning skill for which the learner does not yet have skill mastery status.

In another aspect, there is provided a system for learning assessment comprising: a learning assessment database comprising a plurality of assessment modules; an interactive assessment device comprising a screen for displaying an assessment module to a learner from the plurality of assessment modules and a processor for receiving learner assessment data relevant to the assessment module; a learner profile database comprising a plurality of learner profiles for a plurality of learners, each learner profile comprising a learner identification and the learner assessment data from each assessment module attempted by the learner; and a prescriptive learning engine for receiving the learner assessment data for the learner and prescribing at least one learning activity based on the learner assessment data.

In an embodiment, the system further comprises a learning activities database comprising a plurality of learning activities.

In another embodiment, the system further comprises a learning milestones database comprising a plurality of learning milestones, the learning milestones correlated to the learner assessment data.

In another embodiment, the plurality of assessment modules in the learner assessment database are assigned to at least one learning domain.

In another embodiment, the interactive assessment device is connected to at least one peripheral assessment tool.

In another embodiment, the plurality of core learning skills for each grade level are set by one or more of a standard curriculum, educational research, school board requirements, and jurisdictional requirements.

In another embodiment, the peripheral assessment tool is a toy, hand puppet, card, tile, or manipulative.

In another embodiment, the at least one peripheral assessment tool comprises an external sensor, embedded sensor, microphone, or camera.

In another embodiment, the interactive assessment device can receive one or more of notes, audio, video, photograph of assessment, voice to text, and sensor data pertaining to the assessment.

In another embodiment, the interactive assessment device further comprises a speaker and the assessment module comprises auditory language instruction for completing the assessment module.

In another embodiment, the learner assessment data comprises one or more of assessment module completion time, error rate, and delay time.

In another embodiment, the prescriptive learning engine receives learning assessment data for a group of learners and prescribes the learning activity for the group of learners based on learning assessment data for the group of learners. In another embodiment, the prescriptive learning engine prescribes a specific learning activity for the group of learners based on the skill mastery in the plurality of core learning skills for the group of learners.

In another embodiment, the prescriptive learning engine receives the identification of skill mastery in the plurality of core learning skills for a group of learners and prescribes a specific learning activity for the group of learners based on the skill mastery in the plurality of core learning skills for the group of learners.

In another embodiment, the interactive assessment device displays the learning assessment module and the processor receives the learner assessment data for the core learning skills being assessed by the learning assessment module.

In another embodiment, the learner information comprises one or more of birth date, grade level, school, teacher, school board, educational history, family information, domestic situation, community or extracurricular associations, learner's interests, cultural group, geographic area, migration history, languages spoken, and first language.

In another aspect there is provided a system for learning assessment comprising: a learning assessment database comprising a plurality of assessment modules; a learner profile database comprising a plurality of learner profiles for a plurality of learners, each learner profile comprising a learner identification and learning assessment data from each assessment module attempted by the learner; a learning activities database comprising a plurality of learning activities; a prescriptive learning engine for receiving the assessment data for the learner and prescribing at least one learning activity from the learning activities database based on the learning assessment data.

In an embodiment, the system further comprises one or more interactive assessment device and peripheral assessment tool.

In another aspect there is provided a method for prescribing an activity to a learner group comprising: for each learner in the learner group, collecting learning assessment data in a learner profile; for each learner in the learner group, providing learning assessment data from the learner profile to a prescriptive learning engine; in the prescriptive learning engine, evaluating learning domain proficiency for the set of learners in the learner group; and selecting a learning activity from a learning activities database for the learner group based on the learning domain proficiency for the set of learners in the learner group.

In an embodiment, the method further comprises updating the learner profile for each learner in the learner group.

In another embodiment, the method further comprises comparing the learning assessment data from each learner profile in the learner group to learning milestones in a learning milestones database.

In another embodiment, the method further comprises assessing the skill mastery a plurality of learners in a learner group by sorting the plurality of learners in the learner group by a selected core learning skill to identify learners in the learning group who do not yet have skill mastery status in the selected core learning skill.

In another embodiment, the method further comprises selecting the at least one learning activity for the learner group based on the core learning skill mastery status for the set of learners in the learner group, and updating the learner profile for each learner in the learner group indicating that the learning activity was completed by each learner in the group of learners.

In another embodiment, the method further comprises comparing the skill mastery status to learning milestones in a learning milestones database.

In another embodiment, the method further comprises the learner profile comprises learner information, and wherein the method further comprises tailoring the learning assessment module based on the learner information.

Embodiments of the present invention as recited herein may be combined in any combination or permutation.

### BRIEF DESCRIPTION OF THE FIGURES

For a better understanding of the present invention, as well as other aspects and further features thereof, reference is made to the following description which is to be used in conjunction with the accompanying figures which illustrate embodiments or aspects of the invention, where:

FIG. 1 illustrates an early learner assessment system;

FIG. 2 illustrates an early learner assessment system with caregiver and educator portals;

FIG. 3 illustrates a method for the creation and updating of a learner profile;

FIG. 4 illustrates a method of using a learning analytics engine for prescribing learning activities to an individual learner or group of learners;

FIG. 5 illustrates an early learning system incorporating the development of culturally sensitive assessments for early learners;

FIG. 6 illustrates assessment approaches based on a learner profile;

FIG. 7 illustrates a method of educator training based on learner profiles;

FIG. 8A is an illustration of a graphical user interface in an educator portal or on an interactive electronic device providing a learner group assessment profile;

FIG. 8B is an illustration of a skill key used by an educator to record core learning skill mastery;

FIG. 9 is an illustration of a graphical user interface of an individual learner assessment profile; and

FIG. 10 is a sample assessment for pattern matching.

### DETAILED DESCRIPTION OF THE INVENTION

Unless defined otherwise, all technical and scientific terms used herein have the same meaning as commonly understood by one of ordinary skill in the art to which this invention belongs. Working examples provided herein are considered to be non-limiting and merely for purposes of illustration.

As used in the specification and claims, the singular forms “a”, “an” and “the” include plural references unless the context clearly dictates otherwise.

The term “comprise” and any of its derivatives (e.g. comprises, comprising) as used in this specification is to be taken to be inclusive of features to which it refers, and is not meant to exclude the presence of any additional features unless otherwise stated or implied. The term “comprising” as used herein will also be understood to mean that the list following is non-exhaustive and may or may not include any other additional suitable items, for example one or more further feature(s), component(s) and/or element(s) as appropriate.

As used herein, the terms “having,” “including” and “containing,” and grammatical variations thereof, are inclusive or open-ended and do not exclude additional, unrecited elements and/or method steps, and that that the list following is non-exhaustive and may or may not include any other additional suitable items, for example one or more further feature(s), component(s) and/or element(s) as appropriate. A composition, device, article, system, use, process, or method described herein as comprising certain elements and/or steps may also, in certain embodiments consist essentially of those elements and/or steps, and in other embodiments consist of those elements and/or steps and additional elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

As used herein, the term “learner” refers to the user for whom the present early learner assessment system and method as designed to be used, for example a student or child. An “early learner” is understood to be a learner who is under the age of about ten years old.

As used herein, the term “caregiver” refers to any adult responsible for caring for the learner in a home or non-school environment. A caregiver can include, for example, one or more parent, grandparents, elder, foster parent, aunt/uncle, older brother/sister, tutor, mentor, counsellor, social worker, etc.

As used herein, the term “educator” refers to one or more person whose primary responsibility in the learner's life is to provide educational opportunities to the learner. The term “educator” includes teachers, educational assistants, educational specialists, and other individuals responsible for teaching the learner in an educational or school environment.

As used herein, the term “learning domain” refers to areas or subjects of learning for early learners. The learning domain includes core and standard curriculum-based learning domains such as, for example, reading, math, and oral language, as well as more flexible or non-traditional curriculum based learning domains such as, for example, holistic math, social and emotional development, logic and reasoning, scientific inquiry, self-monitoring, executive function, and pattern recognition. Other learning domains which are outside traditional curriculum standards but important to the learning and development of early learners which can be included in the present learning domains include culturally and community specific learning domains, regionally specific learning domains, physical and kinesthetic learning domains, artistic and creative learning domains, technical and craft based learning domains, and traditional cultural knowledge learning domains. Each learning domain can have one or more core learning skills associated with it, each of which can be assessed using the present system and method.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, in communication with, operatively associated with, etc., even if there are other elements or features intervening between the elements or features described as being connected.

Herein is described a system and method of early learner assessment using learner profiles and one or more interactive assessment devices to assess the core learning skills of early learners. Assessment of learning in early learners using interactive assessment devices that can be independent of an adult evaluator has been found to be capable of accurately measuring and reporting the learning of a learner on an early learning continuum. Moreover, it has been found that separation of the educator from assessment can provide a more holistic measurement of early learning and removes assessment bias, enabling an early learner to more thoroughly demonstrate their ability across a wide range of learning domains and core learning skills. The present system identifies, for all individual learners in a group of learners, what core learning skills need additional instruction or practice, and what core learning skills have been mastered so teachers can understand what interventions or additional instruction is needed to get their individual students as well as their class as a whole up to grade level.

Collection of various types of learning assessment data during learning assessments with an interactive assessment device provides a granular assessment of a learner's ease with an assessment, as well as identifies any areas of concern associated with core learning skills that would benefit from additional instruction or learning support. The present system and method also assists educators in more strategically delivering focused educational material and activities to individual learners as well as groups of learners to provide a positive and progressive learning environment for all early learners.

The foundational principles of the presently described holistic early learner assessment system and method are game-based assessment, ongoing assessment of learning progression, and personalized learning. Teachers can use the presently described assessments and activities in their small group centers and individual learning stations, allowing every child to have regular sessions and be assessed regularly on key learning skills and concepts. As children complete the offered activities, the interactive learning device can continually collect assessment data without any need for data entry by the teacher. In this way, learning progression in each core learning skill required for learning domain mastery can be regularly assessed such that core skills that need more instruction can be flagged for teacher follow-up. Educators can immediately access data through a secure, online portal, which analyzes and recommends personalized learning plans that teachers can use for small groups centers as well as for specific students that need individualized interventions. Every child is unique and has different strengths and weaknesses along their learning progression. By identifying the weaknesses of particular students in core learning skills the educator can provide enrichment opportunities to grow the student's capabilities in the area in which they are weak to build up their strengths and address their learning challenges. The presently described system and method for assessment of early learning has been specifically designed for specific age groups of early learners, for example pre-kindergarten to grade three, however it is understood that the same system may also be used for other age groups with other learning and activity specific modalities and domains.

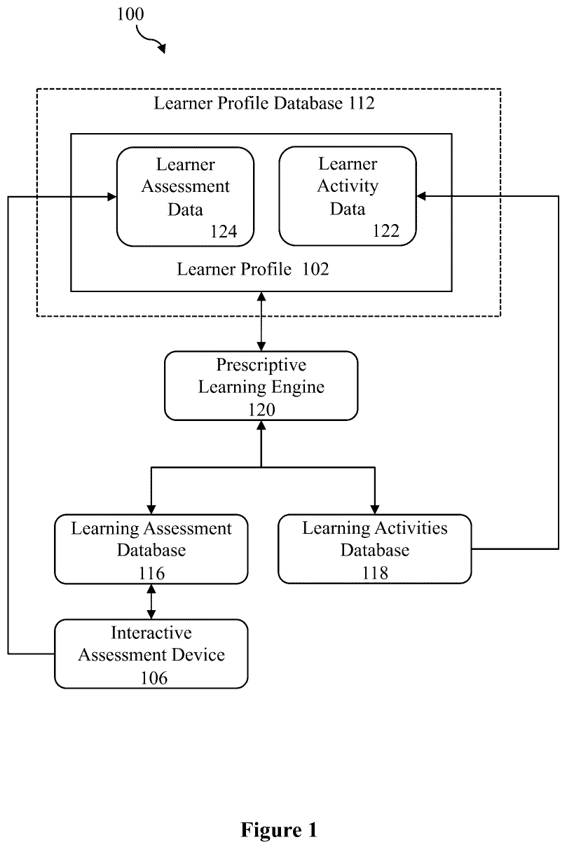

FIG. 1 illustrates an early learner assessment system. The early learner assessment system 100 delivers a learning assessment to a learner on an interactive assessment device 106 and receives learner assessment data 124 from the interactive assessment device 106 to evaluate learning domain proficiency in one or more areas or learning domains being assessed. In an embodiment, the interactive assessment device 106 can be used offline during an assessment, such as in an area where there is no internet connection or an assessment location such as a child's home. The interactive assessment device can also be configured to receive additional inputs such as, for example, notes, audio, video, photographs of the assessment, voice to text, or other inputs recording observations of the assessment or by the educator. The interactive assessment device 106 can store the assessment data and then upload it to the learner profile 102 once reconnected to a network. The learner assessment data 124 is stored in a learner profile 102 which identifies the learner, as well as all assessments completed by the learner as well as the learner assessment data 124 associated with each assessment attempted or completed. Learner assessment data 124 can be used to evaluate learning domain proficiency of the learner across a wide range of learning domains and pertaining to a set of core skills identified by early learning research as being critical to domain mastery.

The learner profile 102 can also include additional information about the learner, such as, for example, birth date, grade level, school, current and past teachers, school board, past educational history, family information such as siblings and their ages, domestic situation, identification of caregivers, community or extracurricular associations, learner's interests, preferred learning modalities, hobbies, sports, and other learner information. Further, each learner profile can be associated with a group within the learner profile database, such as a school, classroom, state, school board, jurisdiction, grade level, assigned teacher, etc. such that students within an associated group can be sorted as a group. Sorting learners within a group, for example a classroom, can assist in identifying which learners within a group require additional learning support to master a particular core learning skill, as will be described in further detail. Survey data collected from caregivers can also be added to each learner profile 102 to further provide information on the learner's interests and educational opportunities outside of the educational environment. Information on the learner's attributes in the learner profile 102 can also include information on a learner's cultural group, local/regional geographic area, migration history, languages spoken, first language, and schooling education. Understanding the languages spoken and preferred by the learner, as well as their cultural background enables the present assessment system and method to tailor learning assessments as well as learning activities to provide language and culturally appropriate content during assessments to put learners at ease. Ensuring that the learner being assessed is in a comfortable environment enables the present system to more accurately assess the learner's core learning domain and core learning skill abilities. A learner profile database 112 stores the learner profiles for a plurality of learners.

As part of the learner profile 102, the learner activity data 122 may have an activity completion log indicating which activities from the learner activity database 118 have been completed by the learner, as well as which learning assessments have been completed by the learner from the learning assessment database 116. The learning activities database 118 comprises a set of learning activities that are classified by at least one learning domain and cover a broad range of learning domains as well as the core skills identified for learning and are tagged such that they can be associated with one or more core skill. In this way a learner whose learning assessment indicates that they have a need for additional practice to master a core skill can be provided with a learning activity from the learning activities database 118 that addresses the particular core skill for practice. In one example of an activity in the learning activities database 118 the activity “Let's Collect” is an activity that will allow for caregivers to use at home objects such as blocks or stuffies and will encourage an early learner to describe characteristics such as size and color about each object, and/or group them into categories. This type of activity encourages verbal and communication skills, and may be recommended to a learner when their assessment demonstrates a need for core skill development in verbal communication and expressive vocabulary. A completed activity can be identified as completed by the caregiver within the caregiver portal. Another example of an activity is “Rhyming Bag” in which an educator or caregiver gathers objects within a classroom and places them in a bag. This type of activity may be recommended for a learner who has, through an assessment, been identified in their learner profile 102 as needing additional help with phonological skills such as rhyme discrimination and rhyme production. When extracted from the bag, the early learners are asked to provide words that would “rhyme” with the object.

When any activity is completed the observations for the learner or child can be recorded within the learner profile as learner activity data. By offering home caregivers easy activities that can be done to help their child learn and identifying specific activities that address core skill deficiencies of a specific learner the present learning system can help early learners advance in the areas where they need the most practice. A record of the attempting and/or completion of a learning activity is stored in the learner profile 102 as learner activity data 122 and can be used to suggest additional learning activities for the learner for educational enrichment. The learning activities database 118 provides content for learning in activity-based modules and can also leverage other content as the basis for learning, which can also be adapted to creating and performing an assessment.

The learning assessment database 116 comprises a plurality of assessment modules for assessing student learning. Each assessment module in the learning assessment database 116 comprises an interactive activity or challenge that can be provided on a digital interactive assessment device 106 or assessed by an assessor on the digital interactive assessment device 106 to assess the skills of a learner in the learning domain assessed by the assessment module. Each assessment module can be specific to a particular learning domain, or may be cross-domain and relevant to more than one learning domain. Assessment modules are based on research for each learning domain and are calibrated for each target grade and domain and assess the learner on one or more core learning skills that have been determined in educational research to be important for domain skill mastery. During the assessment each of the core skills being tested is given a score to evaluate the level of core skill master of the learner. The interactive assessment device 106 can deliver the learning assessment module to the learner from the learning assessment database 116 and can collect assessment data for a particular assessment which can be used to assess learning in the particular learning domain of the learning assessment. The interactive assessment device 106 can be any electronic device that can deliver a graphical display to the learner and/or the assessor or educator for the learning assessment, as well as receive and store data pertaining to learning assessment data pertinent to the learning assessment. Examples of interactive assessment devices 106 include tablets, smartphones, and other smart interactive devices with one or more mode of interactive data input, such as button, switch, or touch screen.

The learner assessment data 124 provides not only an assessment completion log indicating which assessment modules from the learning assessment database 116 have been completed by the user, but also a collection of data obtained for each assessment attempted and/or completed by the learner along one or more core skills. Assessment data collected can include but is not limited to the date and time that the assessment module was attempted and/or completed, the amount of time taken to complete the assessment module, the number of errors made during the assessment, as well as other metrics, as are further explained herein. The learning assessment data can be specific to the domain-based assessments (i.e. reading, oral language, math), and provides an indication of a learner's performance across a broad range of core learning skills based on particular research-based skill domains. Assessment data can also be aligned to the local and/or regional curriculum based on the geography of the student (i.e. provincial and/or state curricula), as well as local achievement milestones set by teachers, schools, or school boards, and can be provided to support teachers and schools in their reporting of student outcomes through an Educator Portal. By receiving learning assessment data across a wide variety of core skill metrics, the learning assessments of the learner are not simply based on passing or not passing the assessment, but are able to more holistically assess how as child or learner measures on a continuum across a broad range of learning core skills. In this way the learning assessments in the learning assessment database 116, which are based on research methods for evaluating an early learner's understanding and mastery of base core skill concepts in core learning domains, can provide more granular data on the learner, how they learn, how they solve problems, and more specifically, where the learner needs additional help to attain skill mastery in particular core skills.

The learner assessment data collected by the interactive assessment device 106 along with any additional learner assessment data collected by one or more peripheral assessment tools and/or sensors can be stored in the learner profile 102 as learner assessment data 124 and can be used to assess learning in the learning domain assessed and core learning skills associated therewith. A prescriptive learning engine 120 receives data from the learner profile 102 including learner assessment data 124 and learner activity data 122 and can provide feedback and recommendations for additional activities for the learner to engage with from the learning activities database 118 that will enrich the learning of the learner. The prescriptive learning engine 120 receives data from the learner profile 102 including learner assessment data 124 in order to provide an assessment of early learners to determine their current learning domain status based on researched metrics for different education modalities. Learner assessment data 124 in each of the tested domains can provide an indication of how each child using the system is developing in acquiring the necessary skills for math, oral language, and reading, as well as other learning domains. This may include specific targets that are set by regulators for measuring early learners and students for meeting specific targets over a given age and grade level.

By leveraging aspects of both the student's assessment outcomes and completed activities, there will be constant reevaluation when new input data is recorded. The prescriptive learning engine 120 can thereby provide an educator and caregiver with a path for constant learning improvement regardless of where the child or learner is on the spectrum of development. For example, if there are specific topics of interest that will result in more active engagement based on the learner's learning profile 102, the prescriptive learning engine 120 will suggest and provide more activities related to these topics. The present system and method consider concepts such as equity and inclusion for marginalized communities and users to reduce bias in both activities delivered and assessments being performed. In this way, the learning of early learners can be fairly assessed in a culturally sensitive way.

Research says 95% of students have the cognitive capacity to read. Every student, regardless of their current reading level, background, or exceptionalities, can benefit from the presently described holistic early learner assessment system and method as it identifies which core skills the early learner still needs to master reading. Based on extensive research and identification of over two hundred core reading skills in five learning domains, student progress in each core skill can be assessed, and monitored for improvement over time. The educator, using assessment data of the learner's core skills can then easily identify skill gaps and teach directly to those gaps to enable the student to progress along their learn-to-read journey. Monitoring each learner's reading progress continuously informs instruction and maximizes every student's reading potential.

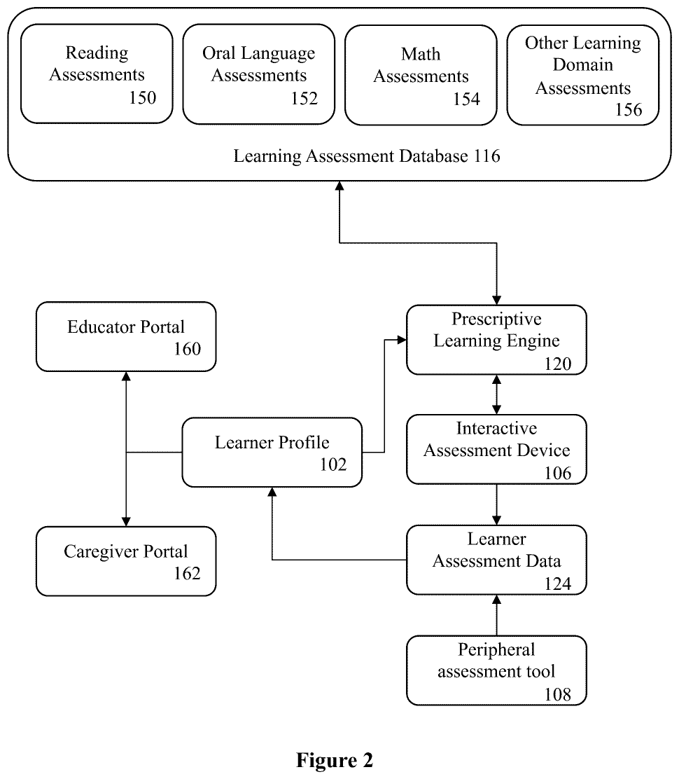

FIG. 2 illustrates an early learner assessment platform with caregiver and educator portals. For any given assessment, a learner is presented with a learning assessment from a learning assessment database 116 on an interactive assessment device 106. The assessment can be for a specific learning domain, or may be cross-domain. For example, the learning assessment may be from one or more of reading assessments 150, oral language assessments 152, math assessments 154, and other learning domain assessments 156. The learning assessment database 116 contains a plurality of learning assessments in a variety of assessment modalities in a plurality of learning domains. In one example, the learning assessment database 116 can provide reading assessments 150, oral language assessments 152, and math assessments 154, with assessments categorized in one or more learning domain. Assessments can also be provided in other learning domains, such as for example creative arts, logic, puzzle solving, cultural learning domains, and others.

Based on a learner profile 102 and progress of the learner along any learning domain continuum along a set of core skills required for mastery of a particular learning domain, an assessment is selected from the learning assessment database 116 by a prescriptive learning engine 120. The prescriptive learning engine 120 receives data from the learner profile 102 to select a learning assessment from the learning assessment database 116 and provides the selected learning assessment to the interactive assessment device 106. In a learning assessment, for example, a learner can be asked to complete a specific task and learner assessment data 124 will be collected by the interactive assessment device 106 and optionally also from one or more peripheral assessment tools 108. Once learning assessment data 124 is collected, the learner profile 102 will be updated accordingly. However, assessment of learning is not only about getting the right answer to the assessment task. Multiple aspects for each assessment are measured as learner assessment data 124 is collected and the learner is tracked while they complete the assessment. Specifically, data that can be collected for each assessment can include but is not limited to start time, end time, response time, number of errors, hesitation time, duration, as well as more granular time and speed tracking during the assessment. During the assessment process, which is dependent on the learning domain, the learner assessment data 124 is updated to include information about a learner's performance of a specific skill or task during the assessment.

The learner profile 102 can also be regularly updated with information about a child's opportunity at home, school, or in the community for learning a particular skill and a child's interest in learning particular skills. In many of the assessments, including holistic math assessments, the assessment can be gamified to motivate the learner to perform their best so as to more accurately evaluate and assess learning. Using these types of interactive assessment devices 106, the system can capture further learner assessment data 124 that goes beyond the learning performance to observe and collect data relevant to the process of learning and characteristic of the thinking that occurs while the child or learner is developing their answer or input to perform a specific task. The learner assessment data 124 collected in these instances focuses on a child or learner's critical thinking skills and measures processes such as, for example, visualization, estimation, problem solving, communication skills, making connections to learning, and reasoning.

In an embodiment, one or more peripheral assessment tools 108 can be used to collect additional data during the assessment that can contribute to the learner assessment data 124 collected for the assessment. In one application, remote sensing can be used to facilitate data collection for the assessment of early learners. Using remote sensing and peripheral assessment tools 108 enables the collection of additional data from learners during learning assessments that could not be obtained using the interactive assessment device 106 on its own. Data collected can include, for example, visual data such as distance of the learner to the interactive assessment device 106, body movements, sounds produced, haptic feedback, as well as time data such as how long the learner takes to do a task, delay time between sub-tasks, error rate, delay after error, and other metrics. The interactive assessment device 106, external sensors, and/or peripheral assessment tools 108 can be used to collect this data, which include toys, hand puppets optionally with embedded sensors, objects, cards, tiles, or manipulatives comprising embedded or external sensors. These devices can be used to collect different digital data streams during child-based activities and assessments. The digital data streams can include, for example, audio data, video data, object manipulation and selection, movement data of the assessment tool or learner, and other data that can assist in learner assessment. In one example, embedded sensors in a puppet, stuffed toy, or similar hand worn device can provide means for an early learner to interact with an interactive assessment device 106 such as a digital tablet and application that is designed for the collection of specific touch based responses for these interactions. These interactions are designed for and represent a specific response during an assessment for one or more domains when evaluating an early learner for specific skills developed or abilities in one or more learning domains. The sensor data collected from the peripheral assessment tool 108 can provide data points that will provide an educator with a better understanding of specific modalities of learning of the learner, including tactile, auditory and kinesthetic, as well as social-emotional development.

Educator portal 160 provides information from the learner profile 102 to an educator and can be equipped with security protections to provide information to the educator to assist with understanding the learner and their needs. A separate caregiver portal 162 also with privacy protections can be provided to inform a caregiver about the learner's progress and also provide a caregiver with suggested activities from the activity database that can be done outside of school for enhanced learning opportunities. For all assessment and activity events, the educator portal 160 and caregiver portal 162 can be updated immediately to reflect the changes.

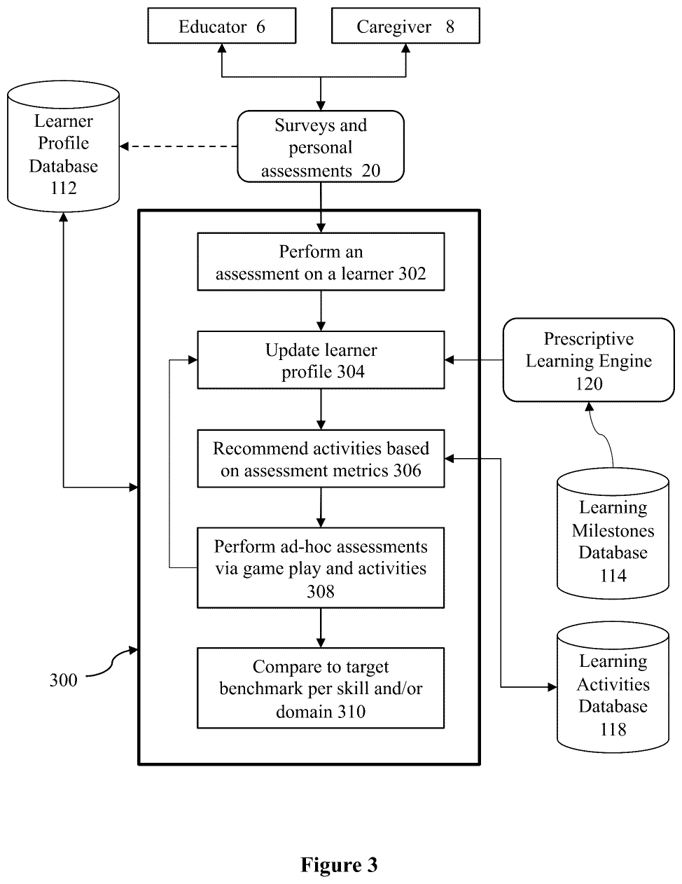

FIG. 3 illustrates a method of creating and updating a learner profile in the present system. The present system and method for learning assessment use a holistic approach to learning assessment that collects data about a child's learning from different people, for example educators 6 such as teachers, as well as caregivers 8 which include family members, community elders, and in different learning locations, for example at home, at school, and in the community. Data can also be collected from the child themselves. Data from surveys and personal assessments 20 are collected from various individuals in the learner's life to get a more fulsome picture of the learner, and this learner data is added to the unique learner profile for the child. The unique learner profile of each learner is stored in the learner profile database 112. The learner profile can include data about the learner gleaned from educator and caregiver surveys, including but not limited to learner interests and learner environment. The learner interests can include, for example, preferred learning modalities, hobbies, sports, etc. The collected data can also provide information about a learner's access to learning particular skills, like access to learning material in the home, such as books, playing cards, puzzles, dice, family language spoken at home, etc. The learner environment can include, for example, family living situation, identification of caregivers, amount of time spent on different interests, identification of community or cultural affiliation, identification of languages spoken, identification of first language, school, school board, grade, age, etc.

Survey and personal assessments 20 can also be collected from educators 6 and caregivers 8 on their observations of the learner. In one example, for a particular activity done with a caregiver 8, the caregiver 8 may be requested to add observation, feedback, and recommendations to more clearly build the learner profile. This can include, for example, time to complete the activity and ease or attitude of the learner during the activity. The learning activities database 118 comprises activities across a wide range of educational domains, which may be domain-specific or cross-domain. This includes activites that broadly cover reading, oral language, math, etc. and can specfically be connected to specific skills under the domains, such as, for example, phonics, reading comprehension, listening and speaking skills, counting, patterning, etc. Access to learning activities and learning materials is made available to the learner outside of the school environment through a wide variety of learning media. This can include, for example, books, time spent with adults such as family and elders, time spent with tutors or counsellors, and time spent playing a variety of types of games. Learning activities at home can also be in as an individual activity or in group activities, or a combination thereof. It is well established that providing a wide range of educational and learning opportunities to learners, especially young children, outside of a school environment in a wide variety of modes enhances child development across all learning domains. These include but are not limited to body movement such as sports and dance, social opportunities with peers as well as intergenerational interactions, and arts activities including music and visual arts and crafts. Providing a wide range activities enhances opportunities for development not only in the specific area of the activity, but across all learning domains. The learning milestones database 114 comprises learning milestones across a wide range of learning domains as well as along a flexible learning trajectory. A learning milestones database 114 can include, for example, learning outcomes and analytics attributes pertaining to a specific domain and/or learning stage, or may be cross-domain and relevant to multiple different learning pathways.

In a method of creating and updating a learner profile 300, an assessment on a learner is performed 302. In performing an assessment on a learner, the learner is provided with an activity, and the assessment evaluates one or more core learning skills in one or more learning domains which are being assessed. The performance of the learner in each of the core learning skills is assessed and a proficiency score of the learner is assigned for each core learning skill being assessed. The assessment can be done by an educator, with input of the assigne proficiency scores by the educator into the interactive learning device, or the assessment may be done automatically on the interactive learning device during the assessment. The learner profile is then updated 304 with learner assessment data and activities recommended based on assessment metrics 306 from the learning activities database 118. The prescriptive learning engine 120 also contributes to updating the learner profie using learner assessment data gleaned from the learning assessment by comparing the learner assessment data to learning milestones for similar learners in the same learning domains from a learning milestones database 114 based on a set of core skills for a particular learning domain. The learning milestones can also be set by one or more of a standard curriculum, educational research, school board requirements, and jurisdictional requirements. Other ad-hoc assessments can be performed via game play and activities 308 and learner assessment data from these ad-hoc assessments can also be added to update the learner profile 304 in the learner profile database 112. The collected learner assessment data can then be compared to target benchmark per skill and/or domain 310.

In language acquisition in early learning, some learning domains include: pragmatics, which are the social rules and cultural nuances that guide communication; syntax, which is the knowledge of how word order, phrases, grammar rules and punctuation are used to transmit meaning; morphological skills, which is an understanding of how words can be broken down into smaller units of meaning, vocabulary, which is the understanding and appropriate use of meaning in single words, phrases and sentences; and oral language and vocabulary, which encompasses syntax and morphology, expressive vocabulary, and receptive vocabulary. The assessment of core skills in early reading includes evaluation of specific core skills in domain areas of oral language and vocabulary, phonological awareness, phonics, fluency, and reading comprehension. Phonological skills encompasses the awareness of the sounds we hear in language, and core learning skills in the area of phonological skills include but are not limited to rhyme discrimination, rhyme production, segmenting (such as sentences, syllables, and sounds), blending (such as sounds and syllables), and sound manipulation (such as sound addition, deletion, and substitution). Each of these core skills can be assessed individually and be assigned a score based on an individual's skill mastery in the core learning skill. Other core learning skills in early reading which can each be assigned a mastery score include but are not limited to: alphabet knowledge of lower and upper case letters; short vowels; long vowels; consonants; digraphs; blends and welded sounds; R-controlled vowels; long vowels; vowel teams; multi-syllable word division; prefixes and suffixes; and orthographical mapping. Reading fluency and reading comprehension also have their own sets of core learning skills, each of which can be assessed individually.

In early math assessment domains for assessment include but are not limited to problem solving, reasoning, estimating, connecting, communication, visualization, and executive function. Assessment for early math learning can be done entirely on the interactive assessment device by the child, without requirement for data entry by the educator, and the learner's skill mastery in each of the core learning skills being tested evaluated and automatically updated in the learner's profile. Learner assessment data can thereby be collected automatically and applied to the learner profile, analyzed to provide personalize learning plans that teachers can use for small group centers as well as for whole class and individual learning for individualized interventions or enrichment. Families can also be provided with simple, off-screen, and personalized activities for their child to develop the skills that they need to work on based on the educational assessments.

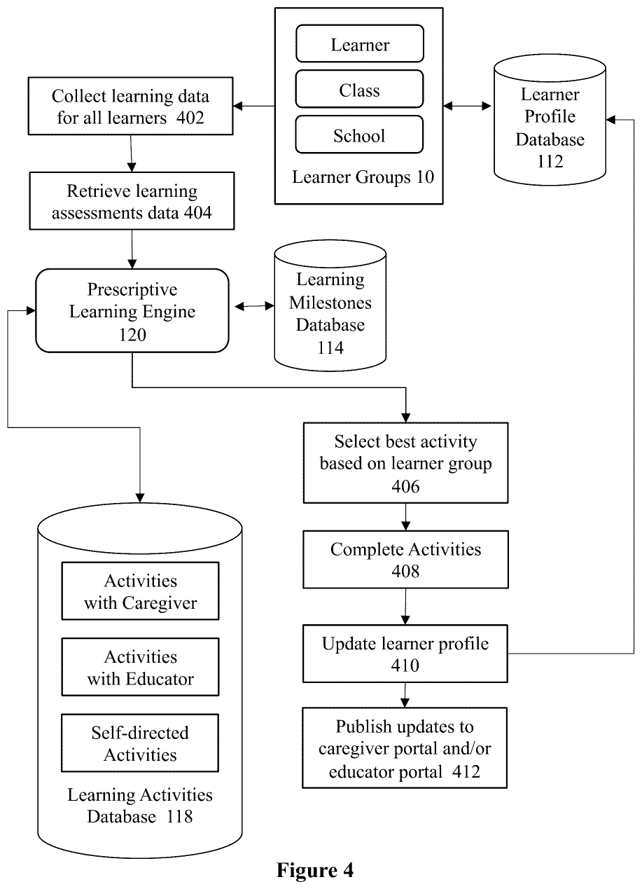

FIG. 4 illustrates the use of a learning analytics engine for prescribing learning activities to an individual learner or group of learners. To generate personalized content for an individual learner or group of learners, data from the set of learner profiles from the learner profile database 112 for a group of learners or learner groups 10 can be used and collated to determine one or more suitable or best recommended activity from a learning activities database 118. The platform workflow will aid an educator to determine plans for each child and group of learners in a learner group such that they can create a teaching plan based on real data about their learner group. To select a learning activity for a learner group 10, learning data is collected for all learners in the learner group 402 from the learner profiles for each learner in the learner group from the learner profile database 112. To do this, learning assessment data from each learner profile in the learner group can be retrieved 404 and displayed as an icon representing skill mastery along a set of core learning skills for each of the learners in the learner group. This learning assessment data can then be fed into a prescriptive learning engine 120 along with learning milestones for the learner group from a learning milestones database 114. The prescriptive learning engine 120 receives assessment data and evaluates learning domain proficiency for a learner or learner group. From this, one or more best activities can be selected based on learner group 406 based on the learning activities in the learning activities database 118. The learning activities database 118 can comprise, for example, activities that the learner does with a caregiver, activities that the learner does with an educator, and self-directed activities. Once the learner group has completed the selected activity or activities 408 the learner profile for each learner in the learner group can be updated 410 and the updates can be published to the caregiver portal and/or educator portal 412.

Activities that are completed will add to a learner's profile and results in changed learner profile details for each learner. Learner profiles can be updated in real time based on learning assessments and learning activities attempted or completed by each learner. Data collection from all learners in a learner group is updated in the learner profile database 112. The learner group 10 may be an individual group of one learner, or may be a set of learners, such as the set of learners in a classroom, a grade, or in a school. To assemble a set of learner profiles from the learner profile database 112, data in the learner profile including age, grade level, educator assignment, classroom assignment, school assignment, education standard, domain, previous assessment data, local/regional curriculums, etc. can be used. For example, the set of all learners assigned to a particular teacher may be assembled as a single learner group. In this way particular learner groups can be identified and the set of learner profiles in each learner group can be analyzed and evaluated as a set to provide activity recommendations to an educator to provide a learning environment and activity to benefit the group, or smaller set of learners, based on the group's skill mastery in a set of core learning skills. The best activities for the larger or smaller group can be determined based on the collective strengths and weaknesses of the learner group as a whole, which based on attributes of each learner as indicated as a score for skill mastery for each core skill in each learner profile.

The learning milestones database 114 comprises a set of learning outcomes and attributes along the desired trajectory of core learning skill acquisition that may include aspects such as curriculum standards, curriculum milestones, and local and regional education standards. The learning milestones database 114 may comprise a standard set of milestone for particular domains and/or age groups, but may also comprise sets of educational milestones specific to regional or cultural groups that are useful in evaluating learner development over time. These may include non-standard domains not usually included in standard curriculum milestones such as, for example, manual dexterity milestones, social/emotional learning, executive functioning, physical milestones, and artistic or creative milestones. The learning milestones database 114 may also include culturally relevant milestones that are important for learners to achieve to grow within their specific cultural group. These may include, for example, knowledge of traditional customs practices, access to elders, knowledge of the language, and participation in traditional activities.

Without being bound by theory, it has been found that learning specific to particular cultural groups is often not evaluated in early learners, but is at least as important and often more important to the development of young children than standard domain-specific curriculum-based learning which is the subject of most educational assessment. Moreover, the teaching and learning of alternative domain knowledge to early learners has been found to enhance the development of early learners in the more standard and standard curriculum-based educational domains such as reading, oral language, and math. Analysis provided helps educators and administrators understand the specific learning outcomes for each child and each class that is using the system. This can provide the means to restructure programs, funding, and other resources to further accelerate the early learning process. Data can also be exported from the present system to allow for usage in a learning management system or another similar learning recordation system.

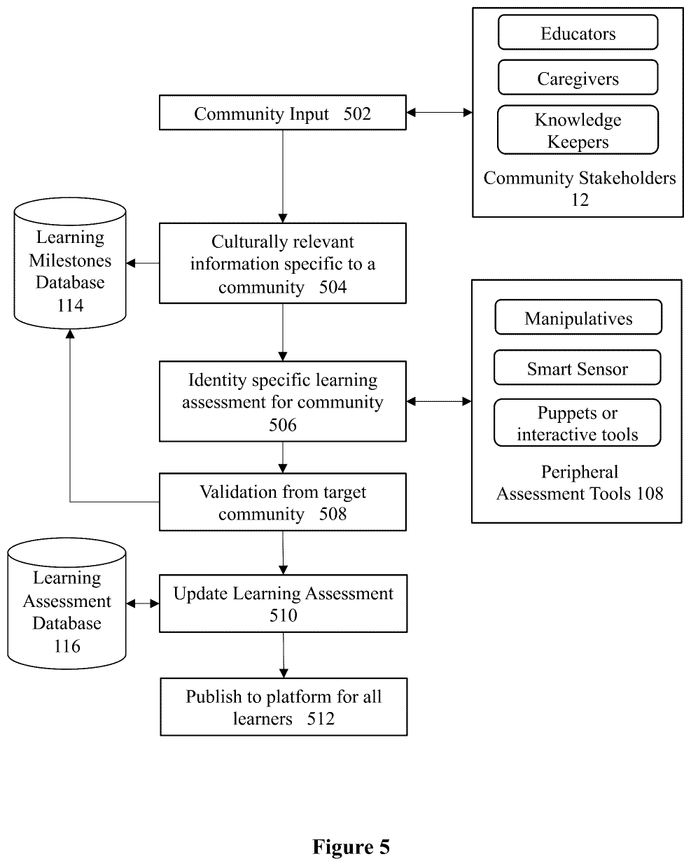

FIG. 5 illustrates an early learning system incorporating the development of culturally sensitive assessments for early learners. Community stakeholders 12 such as caregivers, educators, and other knowledge keepers can be asked for community input 502 and provided with suggestions on activities that can be completed to aid in skills building and development. These activities can be offered as offline activities such as, for example, harvesting medicine, spending time with elders, basket weaving, drumming, music making, and traditional dancing. The learning milestones database 114 can comprise and be updated to include culturally relevant information, attributes and milestones specific to a community 504 based on the cultural learnings and teachings of a particular community or cultural group. Specific learning assessments can also be identified that are appropriate for a specific community 506, and can include one or more culturally appropriate peripheral assessment tools 108, such as manipulatives, smart sensors, puppets, and other interactive tools or toys. In one example, an indigenous community may incorporate particular objects such as utensils, beaded objects, natural objects, or representations thereof, which may optionally include additional sensors, both to teach learners about these objects but also to use them in culturally appropriate learning assessments. To ensure that the learning assessment is culturally appropriate, validation from target community 508 can be done and the learning assessment can be updated 510 based on community feedback. Once the learning assessment has been updated, the learning assessment can be published to the platform 512 in the learning assessment database 116 for the use of all learners. In this way learners can be assessed not only based on traditional learning domains, but also on culturally appropriate and different learning domains that are just as important to the growth and development of young learners. Additionally, cross-domain assessment can be used to evaluate and assess learning along the more traditional curriculum-based domains using culturally and community appropriate attributes to more thoroughly assess learning.

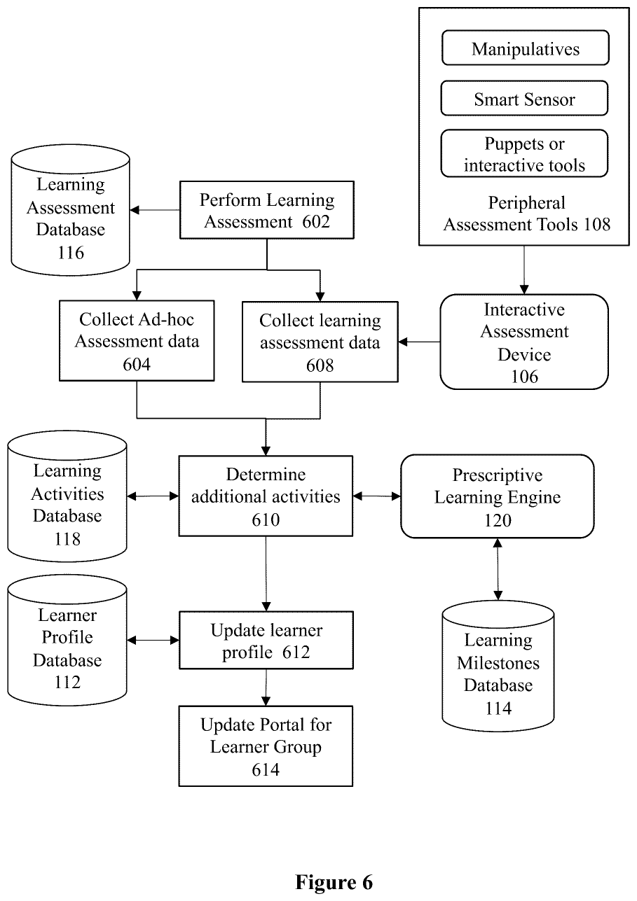

FIG. 6 illustrates an assessment approach based on a learner profile. For a particular learner, a learning assessment is performed 602 from a learning assessment database 116. From the learning assessment, ad-hoc assessment data 604 can also be collected from observers, such as educators and caregivers. The ad-hoc assessment can be done, for example, using via game play or activities. Learning assessment data is also collected 608 from an interactive assessment device 106 on which the learning assessment is done, as well as optionally on one or more peripheral assessment tools 108 equipped with one or more sensors. Once the learning assessment is complete, additional activities can be determined 610 and selected from the learning activities database 118 based on the skill mastery of each of the core learning skills assessed in the learning assessment. The prescriptive learning engine 120 can also evaluate the collected learning assessment data relative to learning milestones in the learning milestones database 114 to suggest additional activities for the learner. The learning milestones database 114 comprises learning outcomes and analytics attributes specific for learners along a learning trajectory. The learner profile in the learner profile database 112 can then be updated 612 and the educator and/or caregiver portals can also be updated for each learner in the learner group 614. Activities that are completed will add to a child's profile to indicated skills improvement. Activities completed also result in changing profile details for each child. Algorithms in the prescriptive learning engine 120 are initialized with every completed activity or assessment which results in updated recommendations for learning. In this way, the most appropriate learning activities as well as future assessments can be selected based on the current strengths and weaknesses of an individual learner or learner group based on the skill mastery of core skills stored in each learner profile(s).

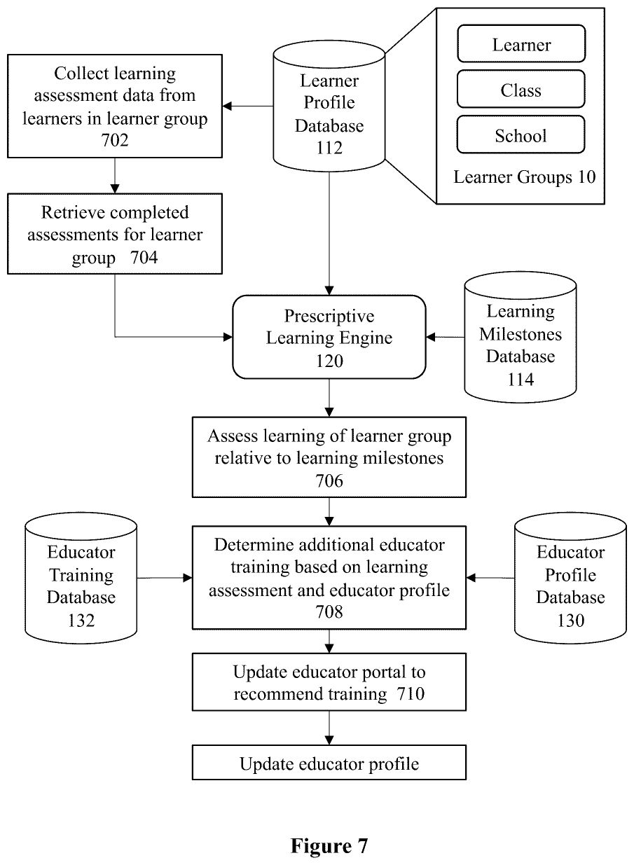

FIG. 7 illustrates a method for educator training based on learner profiles using the present system. In support of on going assessment, learner assessment data can be collected 702 from learners in a learner group 10 from a learner profile database 112. Completed assessments for the learner group can also be retrieved 704. This data is then put into a prescriptive learning engine 120 along with learning milestones from the learning milestones database 114 relevant to the learners in the learner group 10. An assessment of learning of the learner group relative to learning milestones 706 can then be done and additional educator training can be determined based on learning assessment and educator profile 708 of the learner group. Educator profiles can be stored in an educator profile database 130 and educator training modules can be stored in an educator training database 132. Similar to the approach to learning activities, the educator training database includes research-based training methods aligned to the specific core learning skills. For example, if an identified student gap is around spatial reasoning skills in math, the educator can be provided with training connected to the database of teaching methods and professional development modules specific to teaching spatial reasoning for that age group. An educator portal can then be updated to recommend training 710 and an educator profile can also be updated 712. The educator training database 132 can comprise educator training modules with culturally relevance attributes and a catalogue of training materials for an educator based on the educator profile in an educator profile database 130.

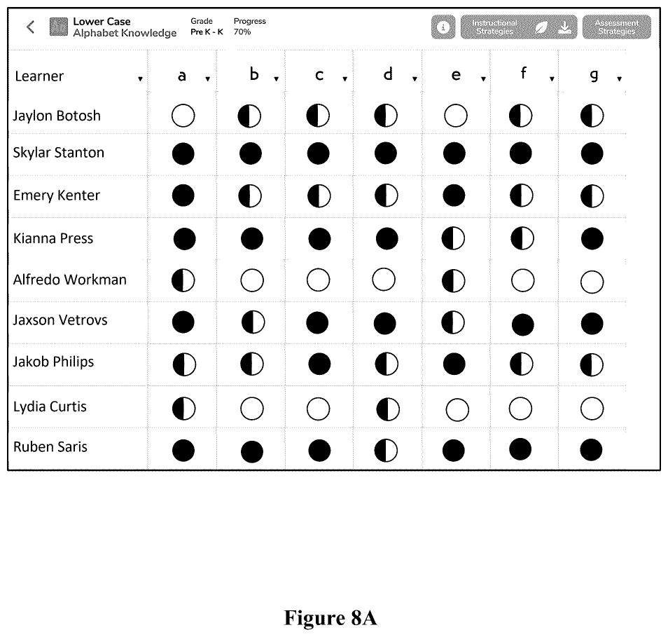

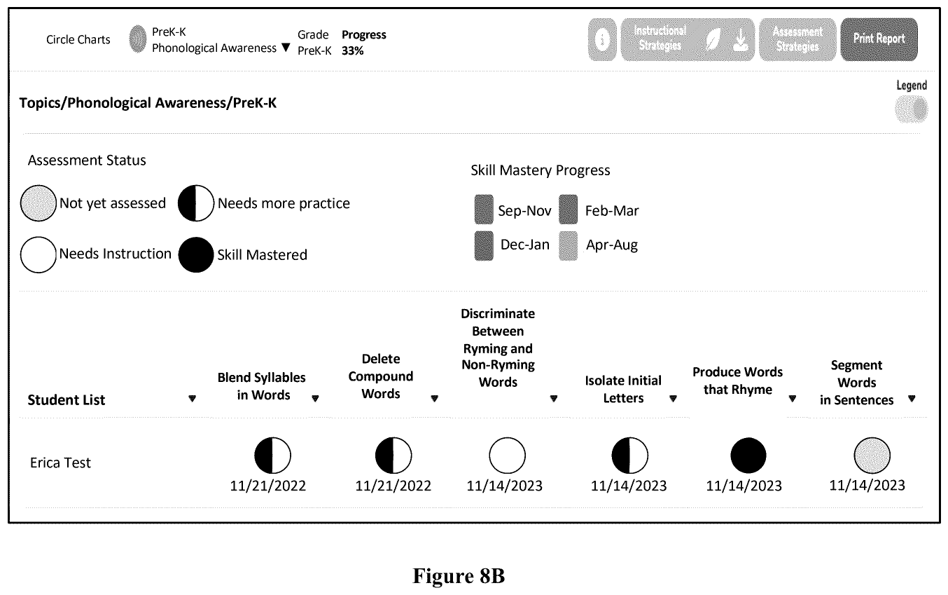

FIG. 8A is an illustration of a graphical user interface in an educator portal providing a learner group assessment profile across a plurality of core learning skills a-g using a circle chart. Every student's learning journey is unique and the presently described personalized learning progress monitoring system and method provides a way to track a learner's progress along core skills and direct their learning specifically to where their core skills need improvement. An educator can provide an assessment of each child along a particular core learning skill for a group of students. This illustration of a graphical user interface on an interactive learning device shows an example of an application interface of a specific target skill set within the reading domain for a group of learners, specifically “Lower Case, Alphabet Knowledge”. For each early learner, a quick evaluation of skill mastery by the educator for this plurality of core learning skills provides an easy mechanism to track and sort the specific skill pre character or letter per child in a circle chart. Each circle symbol represents a different level of skill mastery for the particular core skill and the assigned level for each core skill can be sorted to identify, for example, which students in a learner group have mastered a core learning skill and which need additional practice or instruction to master the core learning skill. The educator can enter this information via an electronic device, such as a tablet or mobile electronic device. Upon entering any information, the learner profile can be updated, and the prescriptive learning engine can provide new and updated activities for each learner profile. Items listed a-g at the top of the chart can be indicators for a listing by core skill, in this case lowercase letter knowledge, and the box next to each learner's name in each column provides a location where an educator can quickly record the skill mastery of a particular learner in a particular skill.

In one example classroom, a teacher can select a particular skill set, for example identification of lowercase letters a-g, and privately ask each learner in the group to identify the letter on a board. The teacher can then and quickly rank the learners in the classroom by skill mastery, identifying which students have not yet mastered the skill and would benefit from additional instruction or a learning activity to assist them in learning the missing core skill. In this way the students can be grouped and regroup based on their specific instructional strengths and needs to support weekly planning and personalized instruction. The teacher can then pull these students into a smaller activity or learning group and provide the instruction or learning activity to the students to improve their skill. Once a core skill is selected for teaching, the interactive assessment device on the educator portal can also provide one or more suggested activities to do with the students to address the deficiency in the core skill. In this way, the teacher can zone in on gaps that the early learner is having with core reading skills and explicitly teach the foundational literacy skill that the child is missing.

The presently described system and method has been found to have a success rate of over 90% classroom reading proficiency by grade three across a wide range of demographic and cultural groups and geographic areas. By supporting differentiated instruction in a whole group classroom setting, small group of learners who are having a challenge with a particular core skill can easily be identified and provided with individual intervention in a group setting. The system can also provide an educator with visual reports to simplify achievement measurement across a classroom, for a particular teacher, or for a school or school boards. Classroom teachers can also be provided with visual reports on the interactive assessment device identifying core skill deficiencies in the classroom that need explicit instruction and practice, and determining potential student groupings for core skill teaching enrichment. In this way, the classroom teacher can cluster learners in a classroom whose learning assessment status for a particular core skill or set of core skills is less than mastery to provide learning enrichment, or an additional learning activity to improve the learner's skill mastery in the core skill(s). Personalized play-based activities can be recommended specifically for a particular classroom that teach the foundational reading skills during whole-class instruction, center-based instruction and/or one-on-one with students based on the core skill mastery of the classroom as a whole, as well as individual students in the classroom.

FIG. 8B is an illustration of a skill key used by an educator to indicate skill mastery for a particular learner. This skill key can be used to, for example, identify learners who need additional instruction to achieve skill mastery or identify students who have already achieved mastery in a particular skill. The legend for the circle charts provides for each one of the following: Not Yet Assessed (empty or grey); needs more practice (half circle); skill mastered (full circle); and needs more or explicit instruction (full white). Each core skill assessment can also be provided with a date stamp, which lets teachers see the exact date when a student was assessed for a particular core skill. The skill key shown pertains to reading in the reading domain of Phonological Awareness in the Pre-Kindergarten or Kindergarten (PreK-K) grade level according to the set of milestones for the particular grade level. The reading domain of Phonological Awareness has a plurality of associated core skills associated with it, each of which can be assessed and assigned an assessment status. In this example, the core skills associated with the reading domain of Phonological Awareness are “blend syllables into words”, “delete compound words”, “discriminate between rhyming and non-rhyming words”, “isolate initial letters of words”, “produce words that rhyme”, and “segment words in sentences”. Much educational research has been done to understand the process that young people go through to learn to read. divide the skill of reading into a plurality of domains and a plurality of core skills that together, when mastered, enable a young child to read. Without mastery of all of the core skills students can be delayed or experience frustration in progressing with reading, and identification of the core skills which a learner hasn't yet mastered has been found to be instrumental in directing enrichment to the student for the particular skill that still requires work.

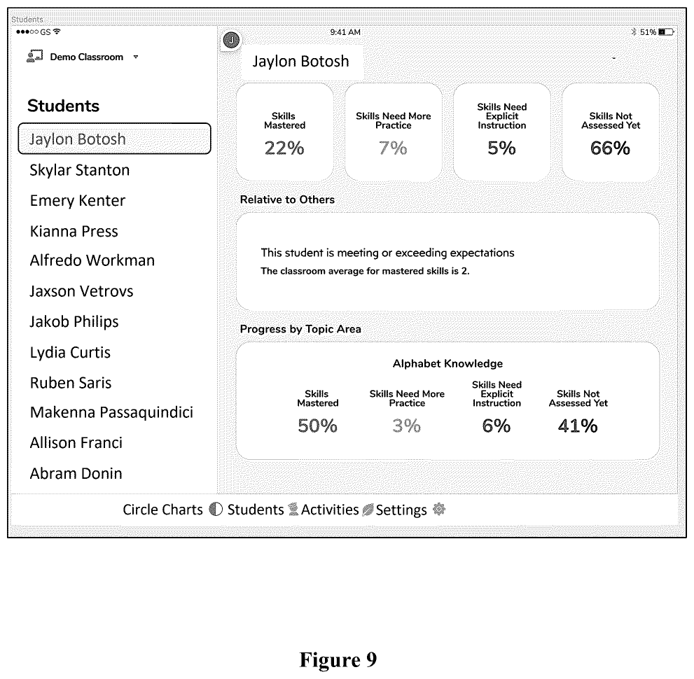

By assessing each core skill independently, the deficiencies of particular learners along their learn-to-read journey can be easily identified and rectified. The present system provides a progress monitoring tool for teachers and educators to regularly track reading progress by evaluating mastery along a plurality of core skills in a plurality of learning domains and providing targeted enrichment or supplemental learning activities to enable learners to progress in core skills that have been identified as not yet having been mastered. It has been found that by monitoring individual core skill progression against research-based benchmarks learners having a particular challenge on a core skill can be easily identified and provided with additional teaching to help them conquer the core skill that they need help with. By collecting assessment data on each learner in this way, on a regular basis, and based on a core skill-specific assessment criteria, the educator can ensure that every student is provided with the tools to master the foundational skills required to read at their grade-level. FIG. 9 is an illustration of a graphical user interface of an individual learner assessment profile. This individual learner profile view shows the preview details for a specific learner within a specific classroom. This information can be provided to an educator or caregiver on the specific completed skills on a per domain basis. This example specifically focuses on reading and illustrates the how this child is progressing towards meeting the target skills for reading for their given target. The target can be set via standards or curriculum that can apply for that early learner, typically based on geographic region. This graphical interface will help at quick glance determine if that early learner is progressing or if additional support, including activities and/or instruction will be necessary.

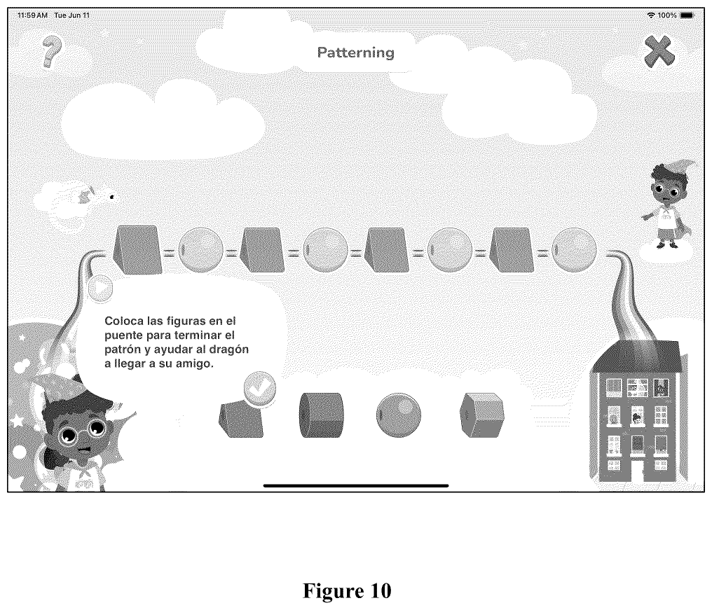

FIG. 10 is a sample assessment module for patterning. Presented on a graphical user interface on an interactive assessment device, the assessment provided is a colorful, engaging, and level appropriate task for a young learner. In this example, a pattern matching assessment is shown where the learner is instructed to drag the correctly colored and shaped bead to match a bead already in a line. In this assessment, when the learner attaches the correct bead to the line, the character will hop to the next spot to re-enforce the desired action for the learner being assessed. If the learner makes any mistakes or takes their time, this data can be tracked and recorded in the assessment data. In addition, the time taken for each “bead” selected as well as completion time and other metrics can be stored in the learner profile. To familiarize the learner with the assessment, a physical kit in the class room having the objects depicted in the assessment, such as manipulatives like the string and beads shown, aid the learner to identify the virtual object with a real one that they are familiar with. When student sits down for assessment with a digital version of the manipulative that they have already interacted with in class to do the assessment it has been found that the child more quickly adapts to the digital assessment and the assessment more accurately tests the child's core skills being assessed. Learning assessment data in this particular example can have many different data points which can be collected by the interactive learning device, including but not limited to: times asked for help; picking up the wrong choice of bead; how long the bead was held; moving trajectory of the beads; time to move each bead into its correct location; and total time needed to complete the assessment. Flags which illustrate measurement outside of the norm can also be indicative of other concerns, such as attention loss, movement fluidity, distractibility, aural comprehension, colour differentiation, adaptability to digital tools, analytical skills, and executive function.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A system for learning assessment comprising:
a learning assessment database comprising a plurality of learning assessment modules and a plurality of core learning skills, each learning assessment module associated with and for assessing one or more core learning skills;
an interactive assessment device comprising a display screen and an assessment application displayed on the display screen to receive learner assessment data for the one or more core learning skills being assessed, and a processor for receiving the learner assessment data relevant to the learning assessment module;
a learner profile database comprising a plurality of learner profiles for a plurality of learners, each learner profile comprising a learner identification, the learner assessment data from each learning assessment module attempted by the learner, and an identification of skill mastery of the learner in the plurality of core learning skills in the learning assessment database;
a learning activities database comprising a plurality of learning activities, each learning activity associated with the one or more core learning skills; and
a prescriptive learning engine for receiving the identification of skill mastery of the learner in the plurality of core learning skills for at least one learner and prescribing at least one learning activity from the learning activities database based on the skill mastery of the at least one learner in the one or more core learning skills.

2. The system of claim 1, wherein the plurality of core learning skills for each grade level are set by one or more of a standard curriculum, educational research, school board requirements, and jurisdictional requirements.

3. The system of claim 1, further comprising a learning milestones database comprising a plurality of learning milestones.

4. The system of claim 1, wherein the interactive assessment device can receive one or more of notes, audio, video, photograph of assessment, voice to text, and sensor data pertaining to the assessment.

5. The system of claim 1, wherein the interactive assessment device is connected to a peripheral assessment tool, and the peripheral assessment tool collects additional learner assessment data which is added to the learner profile.

6. The system of claim 5, wherein the peripheral assessment tool is a toy, hand puppet, card, tile, or manipulative.

7. The system of claim 5, wherein the peripheral assessment tool comprises an external sensor, embedded sensor, microphone, or camera.

8. The system of claim 1, wherein the interactive assessment device further comprises a speaker and the assessment module comprises auditory language instruction for completing the assessment module.

9. The system of claim 1, wherein the learner assessment data comprises one or more of assessment module completion time, error rate, and delay time.

10. The system of claim 1, wherein the prescriptive learning engine receives the identification of skill mastery in the plurality of core learning skills for a group of learners and prescribes a specific learning activity for the group of learners based on the skill mastery in the plurality of core learning skills for the group of learners.

11. The system of claim 1, wherein the interactive assessment device displays the learning assessment module and the processor receives the learner assessment data for the core learning skills being assessed by the learning assessment module.

12. The system of claim 1, wherein the learner profile comprises learner information, and wherein the learning assessment module is tailored based on the learner information.

13. The system of claim 12, wherein the learner information comprises one or more of birth date, grade level, school, teacher, school board, educational history, family information, domestic situation, community or extracurricular associations, learner's interests, cultural group, geographic area, migration history, languages spoken, and first language.

14. A method for assessing an early learner comprising:
providing a learner with a learning assessment module, the learning assessment module associated with a plurality of core learning skills;
assessing the learner on the plurality of core learning skills;
for the learner, assigning a skill mastery status for each of the plurality of core learning skills being assessed by the learning assessment module;
storing the skill mastery status for each of the plurality of core learning skills in a learner profile for the learner; and
selecting at least one learning activity from a learning activities database, the at least one learning activity associated with at least one core learning skill for which the learner does not yet have skill mastery status.

15. The method of claim 14, further comprising assessing the skill mastery a plurality of learners in a learner group by sorting the plurality of learners in the learner group by a selected core learning skill to identify learners in the learning group who do not yet have skill mastery status in the selected core learning skill.

16. The method of claim 15, further comprising selecting the at least one learning activity for the learner group based on the core learning skill mastery status for the set of learners in the learner group, and updating the learner profile for each learner in the learner group indicating that the learning activity was completed by each learner in the group of learners.

17. The method of claim 14, further comprising comparing the skill mastery status to learning milestones in a learning milestones database.

18. The method of claim 14, wherein the learner profile comprises learner information, and wherein the method further comprises tailoring the learning assessment module based on the learner information.

19. The method of claim 18, wherein the learner information comprises one or more of birth date, grade level, school, teacher, school board, educational history, family information, domestic situation, community or extracurricular associations, learner's interests, cultural group, geographic area, migration history, languages spoken, and first language.
